(19) United States
(12) Patent Application Publication
(10) Pub. No.: US 2022/0050439 A1
(43) Pub. Date: Feb. 17, 2022

(54) Device Control Apparatus and Device Control System

(71) Applicant: Hitachi, Ltd., Chiyoda-ku, Tokyo (JP)

(72) Inventors: Nahoko MARUYAMA, Tokyo (JP); Shinji NAKAGAWA, Tokyo (JP)

(21) Appl. No.: 17/298,713

(22) PCT Filed: Dec. 4, 2019
(86) PCT No.: PCT/JP2019/047374

§ 371 Date: Jun. 1, 2021

(30) Foreign Application Priority Data
Dec. 19, 2018 (JP) 2018-237112

(51) Int. Cl. G05B 19/4155

(52) U.S. Cl. CPC G05B 19/4155; G05B 2219/33007

(57) ABSTRACT

Provided is a device control apparatus and a device control system capable of learning a range or area that needs to be taken as a relationship between a state of a control object and a state of a user, and suitably changing a control mode when the relationship is different from a normal one. A device control apparatus 10 includes: an information acquisition unit that acquires first information on a user, second information on a control object 106, and third information on a surrounding environment of the user or the control object 106; a relationship determination unit 104 that acquires a range or area that needs to be acquired as a relationship between the first information and the second information and a range or area that needs to be acquired as a relationship between the first information and the third information in a first state defined from states of the user and the control object 106; and a control mode change unit 105 that changes a control mode of the control object when at least one of the range or area that needs to be acquired as the relationship between the first information and the second information and the range or area that needs to be acquired as the relationship between the first information and the third information is different from the first state.

### TECHNICAL FIELD

The present invention relates to a device control apparatus, and more particularly to a device control apparatus and a device control system capable of changing a control mode according to a state of a user.

### BACKGROUND ART

Control systems have been automated, and the number of people (users) involved in control has decreased regarding many automatic control systems. On the other hand, a user still performs an operation of monitoring whether an automatic system is correctly operating and taking measures to return to a normal state in the event of an abnormality. When users' own states are abnormal due to a decrease in number of users so that a mistake occurs, it is difficult to prevent the influence on the operation, performance, and accuracy of the system.

Under these circumstances, for example, PTL 1 discloses a technique for increasing the volume or slowing down a sound generation speed such that a user can hear a sound properly when the user riding a car is in poor physical condition. Further, for example, PTL 2 discloses a technique for determining an operator's psychological state from a voice input in a device that controls a device such as a plant by the voice input and guiding a correct operation procedure when the operator's psychological state is not normal.

### CITATION LIST

### Patent Literature

PTL 1: JP 2006-88753 A

PTL 2: JP H09-265378 A

### SUMMARY OF INVENTION

### Technical Problem

However, the configuration described in PTL 1 does not consider that a user state may change depending on an operating state of a vehicle. As a result, for example, when a driver is tense on a rough road, there is a possibility that an unnecessary operation is performed by recognizing that the driver is in poor physical condition.

Even in the configuration described in PTL 2, the operator's state is not acquired in consideration of a state of the plant, and thus, there is a possibility that a proper operation is not possible when the operator changes the psychological state properly in accordance with an abnormal state of the plant. Furthermore, when the operator is in an abnormal state, the plant is controlled by a control flow registered in advance, and thus, there is a problem that it is difficult to deal with a plant state where no flow has been registered.

Therefore, the present invention provides a device control apparatus and a device control system capable of learning a range or area (hereinafter, may be simply referred to as a relationship) that needs to be acquired as a relationship between a state of a control object and a state of a user, and suitably changing a control mode when the relationship is different from a normal one.

### Solution to Problem

In order to solve the above problems, a device control apparatus according to the present invention includes: an information acquisition unit that acquires first information on a user, second information on a control object, and third information on a surrounding environment of the user or the control object; a relationship determination unit that acquires a range or area that needs to be acquired as a relationship between the first information and the second information and a range or area that needs to be acquired as a relationship between the first information and the third information in a first state defined from states of the user and the control object; and a control mode change unit that changes a control mode of the control object when at least one of the range or area that needs to be acquired as the relationship between the first information and the second information and the range or area that needs to be acquired as the relationship between the first information and the third information is different from the first state.

Further, a device control system according to the present invention includes: a control object; and a device control apparatus that controls the control object. The device control apparatus includes: an information acquisition unit that acquires first information on a user, second information on a control object, and third information on a surrounding environment of the user or the control object; a relationship determination unit that acquires a range or area that needs to be acquired as a relationship between the first information and the second information and a range or area that needs to be acquired as a relationship between the first information and the third information in a first state defined from states of the user and the control object; and a control mode change unit that changes a control mode of the control object when at least one of the range or area that needs to be acquired as the relationship between the first information and the second information and the range or area that needs to be acquired as the relationship between the first information and the third information is different from the first state.

### Advantageous Effects of Invention

According to the present invention, it is possible to provide the device control apparatus and the device control system capable of learning the range or area (hereinafter, may be simply referred to as the relationship) that needs to be acquired as the relationship between the state of the control object and the state of the user, and suitably changing the control mode when the relationship is different from the normal one. For example, when the user is tense in a case where the control object is normal, or when the user is relaxed in a case where the control object is abnormal, it can be determined that the state of the user is abnormal.

Other objects, configurations, and effects which have not been described above become apparent from embodiments to be described hereinafter.

### BRIEF DESCRIPTION OF DRAWINGS

FIG. 1 is an overall schematic configuration diagram of a device control system of a first embodiment according to one embodiment of the present invention.

FIG. 2 is a flowchart illustrating a control flow of a device control apparatus illustrated in FIG. 1.

FIG. 3 is a block diagram for describing a method for determining a first state.

FIG. 4 is a time chart for describing the method for determining the first state.

FIG. 5 is a conceptual diagram of a relationship when biometric information (heart rate) of a user (operator) is used and control using the relationship.

FIG. 6 is a graph illustrating a relationship between the unsteadiness of a thermal power plant and the biometric information (heart rate) of the user (operator) and an acquisition example for each user.

FIG. 7 is a graph illustrating an example of a method for acquiring a reaction time.

FIG. 8 is a graph illustrating the method for acquiring the reaction time of the user (operator) when a value of the thermal power plant that should vary does not vary within a certain time.

FIG. 9 is a conceptual diagram of a relationship between the unsteadiness of the thermal power plant and the reaction time of the user (operator) and control using the relationship.

FIG. 10 is a view conceptually illustrating a control panel of the thermal power plant as a control object.

FIG. 11 is a conceptual diagram of a relationship between numerical values obtained from a user information acquisition unit and a surrounding environment information acquisition unit illustrated in FIG. 1 and control using the relationship.

FIG. 12 is a flowchart illustrating a control mode change flow.

FIG. 13 is a graph illustrating a difference in the relationship between the unsteadiness of the thermal power plant and the biometric information (heart rate) of the user (operator) in the first state.

FIG. 14 is a flowchart illustrating a control mode change flow when an abnormality in a state of the user (operator) continues.

FIG. 15 is a flowchart when a device control apparatus of a second embodiment according to another embodiment of the present invention changes to a control mode in which an operation of a user is invalidated for a certain period of time.

FIG. 16 is a flowchart when a device control apparatus of a third embodiment according to still another embodiment of the present invention changes an operable range of a user.

FIG. 17 is a graph illustrating an example of a stepwise change of the operable range.

FIG. 18 is a graph illustrating an example of a continuous change of the operable range.

FIG. 19 is a flowchart when a device control apparatus of a fourth embodiment according to still another embodiment of the present invention returns from a mode of changing an operable range of a user.

### DESCRIPTION OF EMBODIMENTS

Hereinafter, embodiments of the present invention will be described with reference to the drawings.

### First Embodiment

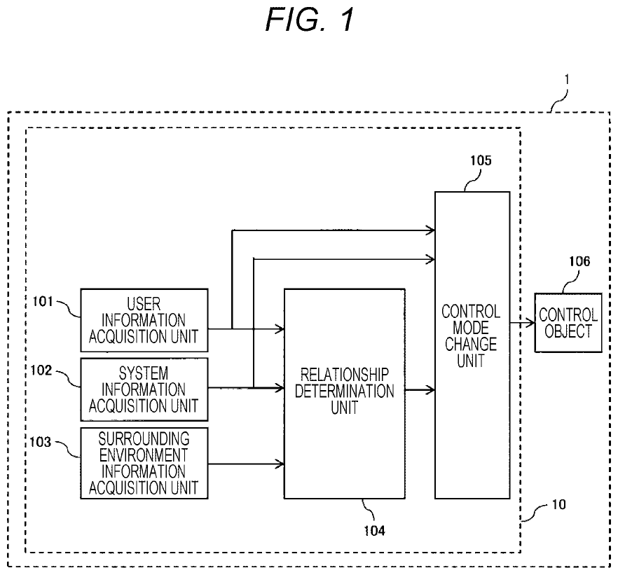

FIG. 1 is an overall schematic configuration diagram of a device control system of a first embodiment according to one embodiment of the present invention. As illustrated in FIG. 1, a device control system 1 is constituted by a control object 106 and a device control apparatus 10 that controls the control object 106. Although a control system of a plant will be described below as an example of the device control system 1 in the present embodiment, but the present invention is not limited thereto.

The device control apparatus 10 includes a user information acquisition unit 101, a system information acquisition unit 102, a surrounding environment information acquisition unit 103, a relationship determination unit 104, and a control mode change unit 105. These user information acquisition unit 101, system information acquisition unit 102, surrounding environment information acquisition unit 103, relationship determination unit 104, and control mode change unit 105 are realized by, for example, a processor such as a CPU (not illustrated) and storage devices such as a ROM that stores various programs, a RAM that temporarily stores data in a calculation process, and an external storage device. The processor such as the CPU reads and executes the various programs stored in the ROM, and stores a calculation result, which is an execution result, in the RAM or the external storage device.

The user information acquisition unit 101 acquires information that can authenticate a user (for example, a vein pattern, an iris pattern, a user's ID card, a fingerprint, a voiceprint, a face, a password, an ID number, or information having the same function as these), information on a user's motion (for example, a frequency, a change amount, a position of a hand, a foot, or a line of sight, and the like of a motion of a hand and a foot, facial expressions, and a motion of eyes including facial expressions, a motion of an eye, back stretching, and the like without being limited to a motion for operating a device), and user's biometric information (a heartbeat, a pulse, respiration, a brain wave, a cerebral blood flow, a body temperature, sweating, and the like). Hereinafter, information that can authenticate the user, the information on the user's motion, and the user's biometric information are collectively referred to as user information.

The system information acquisition unit 102 acquires a value (control parameter) that can be controlled by the user, a value describing a phenomenon that occurs as a result of the control, and a value describing a phenomenon that has occurred regardless of a user's intention (control) regarding a system of the control object 106. For example, if the control object 106 is a thermal power plant, the value that can be controlled by the user is the amount of fuel, the value describing the resulting phenomenon is a combustion temperature, and the value describing the phenomenon that has occurred regardless of the user's intention is the remaining amount in a fuel tank.

The surrounding environment information acquisition unit 103 acquires information on the user and the surrounding environment of the control system that can be perceived by the user (for example, temperature, room temperature, humidity, brightness, a sound frequency, sound loudness, sound duration, a time zone, and an odor).

The relationship determination unit 104 acquires a range or area that needs to be acquired (sometimes referred to simply as “relationship”) as a relationship between the user information obtained from user information acquisition unit 101 and a numerical value obtained from the system information acquisition unit 102. Further, the relationship determination unit 104 acquires a range or area that needs to be acquired as a relationship between the user information obtained from the user information acquisition unit 101 and a numerical value obtained from the surrounding environment information acquisition unit 103.

Furthermore, the relationship determination unit 104 determines whether a current state of the user and the system as the control object 106 is a first state based on current information obtained from the user information acquisition unit 101 and the system information acquisition unit 102. Further, the relationship determination unit 104 determines whether a range or area that needs to be acquired as a calculated current relationship between the information of each user and information of the control object is the same as a correlation in the first state.

The control mode change unit 105 changes a control mode according to a result of the determination on whether the range or area that needs to be acquired as the current relationship between the information of each user and the information of the control object is the same as the correlation in the first state obtained by the relationship determination unit 104.

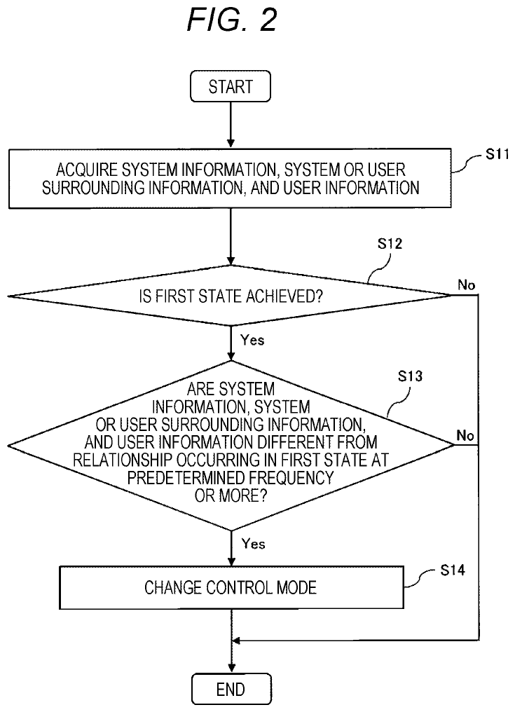

FIG. 2 illustrates a flowchart illustrating a control flow of the device control apparatus 10 illustrated in FIG. 1. First, in Step S11, the user information acquisition unit 101 acquires the user information, and the system information acquisition unit 102 acquires the value (control parameter) that can be controlled by the user, the value describing the phenomenon that occurs as the result of the control, and the value describing the phenomenon that has occurred regardless of the user's intention (control) regarding the system of the control object 106. Further, the surrounding environment information acquisition unit 103 acquires the information on a surrounding environment of the user and the control system as the control object 106.

In Step S12, the relationship determination unit 104 determines whether or not the first state is achieved. If a result of the determination is not the first state, the processing proceeds to Step S13. On the other hand, if the result of the determination is the first state, the processing ends without changing the control mode. Instead, a first state determination unit may be provided in the device control apparatus 10, and the first state determination unit may be configured to execute Step S12.

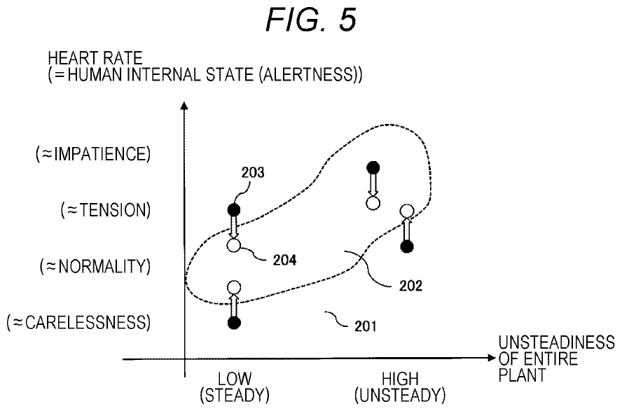

In Step S13, the relationship determination unit 104 determines that the system information, system or user surrounding information, and the user information are different from a relationship that occurs at a predetermined frequency or more in the first state (are within an area 201 in FIG. 5 and within an area of a relationship 202 between a state of the thermal power plant and a state of the user (operator) obtained during acquisition of data of the first state, which will be described in detail later). If a result of the determination is “different”, the processing proceeds to Step S14. On the other hand, if the determination result is that the system information, the system or user surrounding information, and the user information are equal to the relationship occurring at the predetermined frequency or more in the first state, the processing ends without changing the control mode.

In Step S14, the control mode change unit 105 changes the control mode.

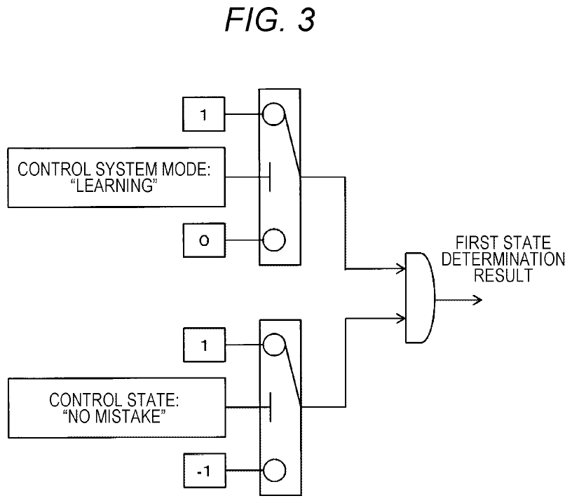

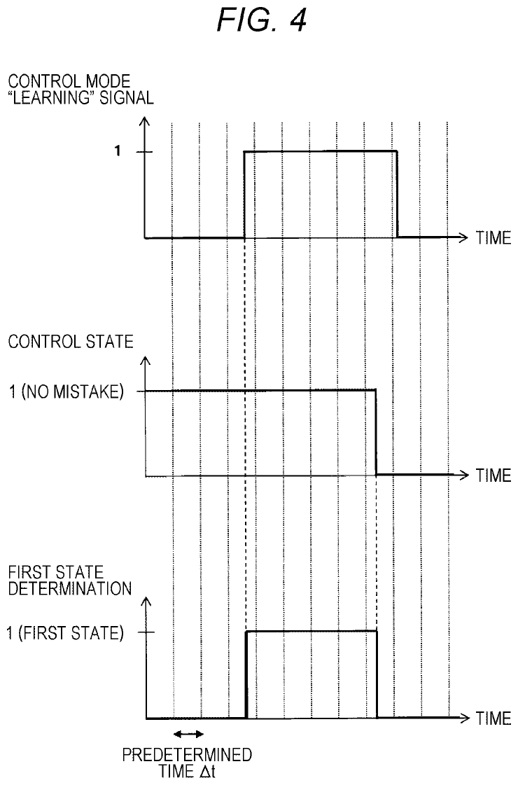

Note that the first state indicates a mode for learning the relationship among the system information, the system or user surrounding information, and the user information. That is, the first state is a learning mode executed before operating a plant as the control object 106. The first state is determined based on whether the control system as the control object 106 is in a learning mode in a section declared as good as a result of the user's declaration regarding the degree of goodness of his/her own mental/physical state and control state every predetermined time Δt. FIG. 3 illustrates a block diagram for describing a method for determining the first state, and FIG. 4 illustrates a time chart for describing the method for determining the first state. When a mode of the control system is “learning” and a control state is “no mistake” as illustrated in FIG. 3, an AND circuit outputs that the determination result is the first state. Further, a signal, which indicates that this timing is the first state from a rise of a “learning” signal to a fall of a “no mistake” signal, is output as illustrated in FIG. 4.

Note that the determination may be made using only information on either whether the system is in the learning mode or whether the user has declared that his/her state and the control state are good. Before activating the control according to the present invention, data in the first state is acquired by asking the user (operator) to control a control system (power plant) for a predetermined time or using a simulator to execute a trial for the user to perform control of the control system (power plant) for a predetermined time, as the learning mode.

Next, FIG. 5 is used to illustrate a relationship when biometric information (heart rate) of the user (operator) is used as the information obtained from the user information acquisition unit 101 regarding the relationship obtained from the user information acquisition unit 101 and the system information acquisition unit 102 in the thermal power plant as the control object 106, and a conceptual diagram of the control using the relationship. The horizontal axis represents the unsteadiness of the entire plant defined by data of the control system (thermal power plant) as the control object 106 acquired from the system information acquisition unit 102, and the vertical axis represents an internal state (alertness) of the user (operator) defined by current information on the user (operator) acquired from the user information acquisition unit 101. The unsteadiness of the entire plant may be defined as, for example, a value decreasing, in order, in an inactive state, during a certain period of time after the start of operation, between the start of an operation end sequence and the inactivation, and until the start of the end sequence since a lapse of a certain time after the start of operation, or a value decreasing as a frequency increases by acquiring a long-term distribution of a temperature inside a furnace and calculating any frequency at which a state occurs based on the current temperature. That is, an operation or control with a high frequency is a steady state, and an operation or control with a low frequency is unsteadiness. The human internal state (alertness) can be defined such that the alertness increases as the heart rate increases, for example. The area 201 acquired in the first state and the area 202 with a strong relationship between the state of the thermal power plant and the state of the user (operator) obtained during the acquisition of data in the first state can be obtained. During the execution of control according to the present invention, the control mode change unit 105 changes the control mode when the state of the thermal power plant or the internal state of the user (operator) correspond to a combination 203 indicated by a black circle that is not within the related range (202) so as to achieve a combination 204 indicated by a white circle to be within the area 202 where the relationship between the state of the thermal power plant and the state of the user (operator) is strong. A method for changing the control mode will be described later.

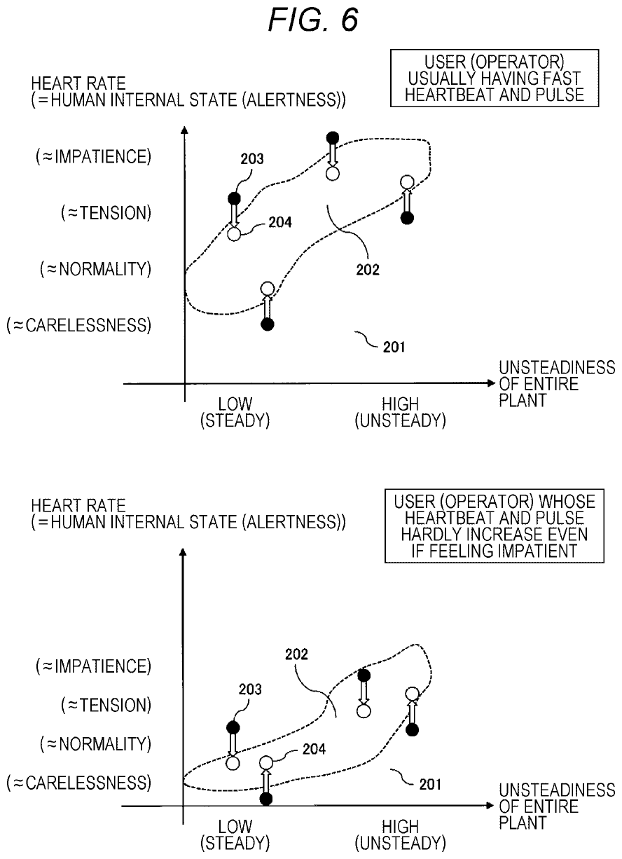

Note that the area 201 and the area 202, with the strong relationship between the thermal power plant and the state of the user (operator) are acquired for each user (operator). As a result, for example, as illustrated in FIG. 6, a heart rate determined as the area 202 becomes high for a user (operator) usually having a fast heartbeat as illustrated in the upper graph of FIG. 6, and the heart rate determined as the area 202 becomes low for a user (operator) whose heartbeat hardly increases even if feeling impatient as illustrated in the lower graph of FIG. 6. Accordingly, an appropriate determination can be made for each user (operator). Further, the area 202 with the strong relationship therebetween can be obtained by past learning data or execution of a simulator for training, for example.

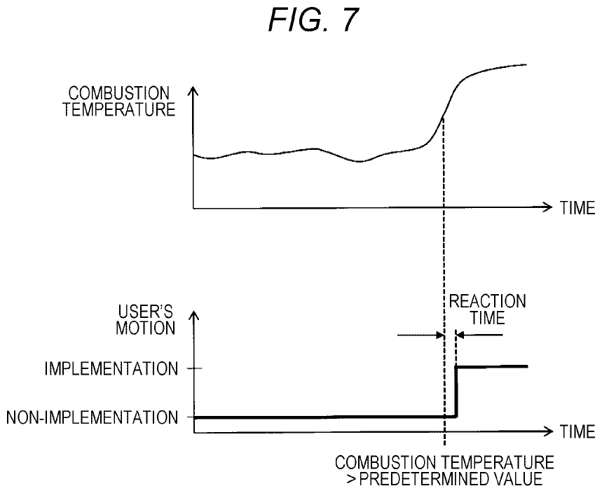

Next, a case where a reaction time of a motion of the user (operator) is used as the user information obtained from the user information acquisition unit 101 regarding the relationship obtained from the user information acquisition unit 101 and the system information acquisition unit 102 will be described with reference to FIGS. 7, 8, and 9. FIG. 7 is a graph illustrating an example of a method for acquiring the reaction time. As illustrated in FIG. 7, a time from the timing at which the state of the thermal power plant as the control object 106 varies, that is, the timing at which a combustion temperature exceeds a predetermined value to the timing at which the user starts a motion (operation) for coping is measured as the reaction time. The determination on a change of the state of the thermal power plant may be input from past operation results of the thermal power plant, or may be made by inputting a pattern defined as a change to a program in advance. Note that a reaction time of the user (operator) when a value of the thermal power plant that should vary does not vary within a certain time is also included in terms that the motion of the user (operator) is required.

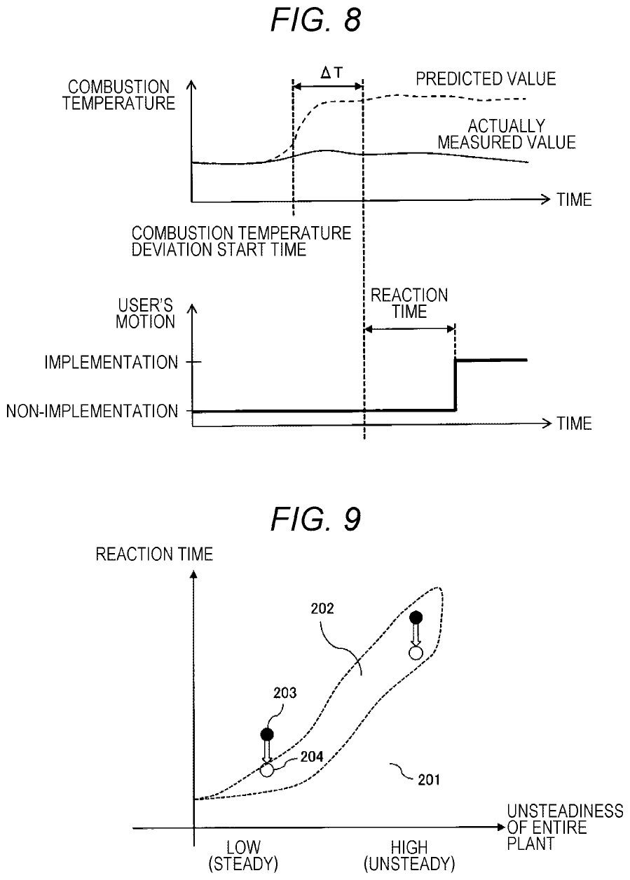

FIG. 8 is a graph illustrating the method for acquiring the reaction time of the user (operator) when the value of the thermal power plant that should vary does not vary within the certain time. In FIG. 8, a predicted value and an actually measured value of the combustion temperature are compared. Here, a value calculated by a simulator may be used as the predicted value, or a value that is regarded to be statistically plausible from past actually measured values may be used. When it can be determined that a new operation is required if a predetermined time ΔT or more has elapsed after the predicted value and the actually measured value deviate from each other by a predetermined value or more, a time until the user (operator) implements the operation since the lapse of ΔT is measured as the reaction time. The predetermined value and the predetermined time ΔT for determining a deviation between the predicted value and the actually measured value may be set in advance for each situation, or may be learned from a change of the state of the thermal power plant in the first state and the motion of the user (operator).

FIG. 9 illustrates a relationship with the unsteadiness of the thermal power plant in a case where a reaction speed of the user (operator) is used as the user information obtained from the user information acquisition unit 101 regarding the relationship obtained from the user information acquisition unit 101 and the system information acquisition unit 102 in the thermal power plant, and a conceptual diagram of the control using the relationship. A difference from FIGS. 5 and 6 is that the vertical axis represents the reaction time. If the state of the thermal power plant as the control object 106 is steady, it is considered that the user (operator) is sufficiently accustomed, and thus, can instantly determine what to do, and the reaction time is short. On the other hand, it is considered that the reaction time becomes long in order for the user (operator) to consider the optimum operation if the unsteadiness increases. If the user (operator) is in a state of carelessness or impatience and the concentration for making the optimum determination is interrupted, the reaction time may be longer than usual, or conversely too short. The acquisition of the first state, the acquisition of the relationship, and the change of the control mode are performed in the same manner as the case of using the human biometric information. A method for changing the control mode will be described later.

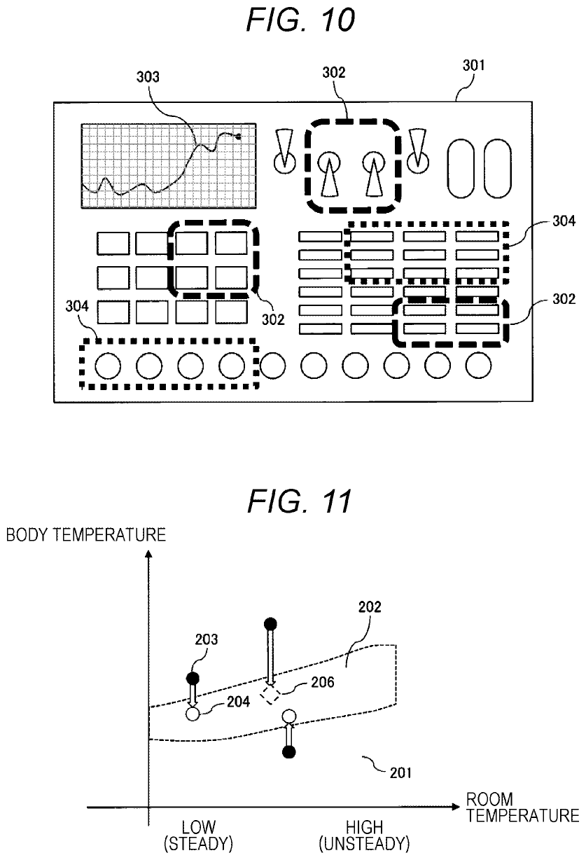

Next, a description will be given regarding a case where an operation pattern is used as the motion of the user (operator) which is the user information obtained from the user information acquisition unit 101 regarding the relationship obtained from the user information acquisition unit 101 and the system information acquisition unit 102. FIG. 10 is a view conceptually illustrating a control panel (which may be displayed as a virtual button or the like on a monitor) of the thermal power plant as the control object 106. When an increase in combustion temperature that is not intended by the user (operator) is displayed on a monitor 303 in a control panel 301 of the thermal power plant, an operation that needs to be taken by the user (operator) can be visualized on the control panel 301 as in an area 302. Here, a black circle at a right end of a time waveform of the combustion temperature displayed on the monitor 303 illustrated in FIG. 10 indicates a current combustion temperature. Further, an area 304 that should not be operated because a situation becomes worse can also be visualized as illustrated in FIG. 10. If the user (operator) has not properly performed an operation with buttons in the area 302, the control mode is changed such that the user (operator) can perform a proper operation. A method for changing the control mode will be described later.

Note that the operation pattern is not necessarily one that is regionally represented by the position of the button and the like, that is, information of zero or one on whether or not to touch the button, and may be pattern information on an operation with higher granularity such as turning of a knob at 40 degrees.

Further, the determinations based on the biometric information, the reaction time, and the operation pattern may be used individually, but if the three determinations are made at the same time and the control mode is changed when it is determined that the state of the user (operator) is abnormal in any one of them, it is possible to more suitably detect the abnormality of the user (operator).

Subsequently, FIG. 11 is used to illustrate a relationship between numerical values obtained from the user information acquisition unit 101 and the surrounding environment information acquisition unit 103 and a conceptual diagram of control using the numerical values. Here, the user information acquisition unit 101 mainly acquires the biometric information of the user (operator). As a result, the time when the user is not in good physical condition mainly can be detected. In the first state, a relationship between the biometric information of the user (operator) and information, such as a room temperature, a sound (intensity, frequency, and duration), humidity, brightness, a time zone, and an odor, acquired as environment information is acquired similarly to the time of acquiring the relationship between the numerical values obtained from the user information acquisition unit 101 and the system information acquisition unit 102. As an example, FIG. 11 illustrates a conceptual diagram of an acquisition result of a relationship between the room temperature as the surrounding environment information of the user and a body temperature as the user information. Note that this relationship does not necessarily have two axes and may be acquired in a multi-dimensional space based on the room temperature around the user, a wind speed around the user (operator), a total amount of clothes of the user (operator), and the like, which is similarly applied regarding the above-described relationship (relationship between the numerical value obtained from the user information acquisition unit 101 and the system information acquisition unit 102). If the combination 203 for which the relationship indicated by the black circle has been obtained is not in the area 202 with the strong relationship, the control mode is changed so as to achieve the combination 204 indicated by the white circle, or such that a change with another user (operator) can be considered when a significantly poor physical condition is assumed, and a relationship among the changed user (operator), the system, and the surrounding environment becomes a combination 206 in the first state for the changed operator. A detailed method for changing the control mode will be described later.

Note that the determinations based on the relationship obtained from the user information acquisition unit 101 and the system information acquisition unit 102 and the relationship between the numerical values obtained from the user information acquisition unit 101 and the surrounding environment information acquisition unit 103 may be made individually. However, if the both are performed and the control mode is changed when an abnormality in the state of the user (operator) is detected in either one, the abnormality of the user (operator) can be detected more suitably.

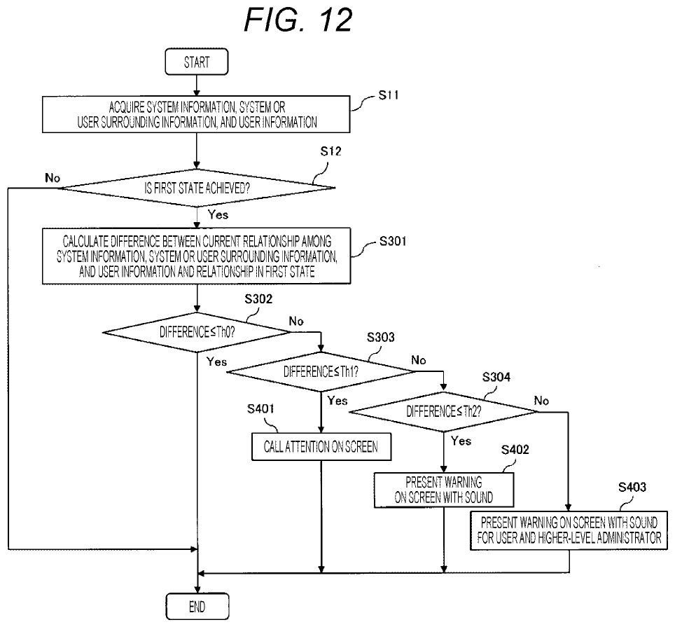

The method of changing the control mode will be described with reference to FIGS. 12, 13, and 14.

FIG. 12 is a flowchart illustrating a control mode change flow. The flowchart illustrated in FIG. 12 illustrates a basic configuration of the control mode change flow (Step S12 and Step S133 in FIG. 2). In this flow, a stronger warning is issued as a difference from the relationship obtained in the first state increases. In FIG. 12, Steps S11 and S12 are the same as those in FIG. 2, and thus, the description thereof will be omitted.

When it is confirmed in Step S12 that the first state is not achieved, a difference between a current relationship among the system information, the system or user surrounding information, and the user information acquired by the relationship determination unit 104 in Step S11 and the relationship in the first state is calculated in Step S301.

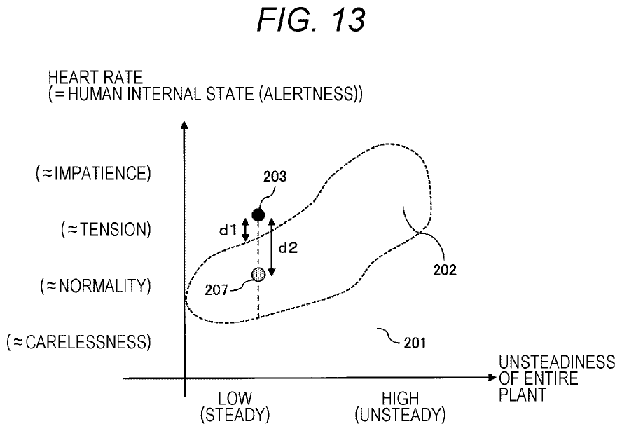

Here, the difference is a distance d1 from an edge of the area 202 in a current plant state, or a distance d2 from a median 207 of a current heart rate indicated by the user (operator) with respect to a current state of the control system (thermal power plant) as the control object 106 in the first state, for example, as illustrated in FIG. 13, when the determination is made using the biometric information of the user (operator). The same determination can be made even when the determination is made using the reaction time of the user (operator) and when the relationship between the information on the user (operator) (mainly biometric information) and the surrounding environment information is used. When the determination is made using the operation pattern of the user (operator), a predetermined virtual distance may be set uniformly in a case where the user (operator) is operating an area other than the operation area 302 that needs to be taken as illustrated in FIG. 10. Alternatively, depending on the strength of a relationship with target control, a virtual distance of an operation that is unnecessary but may be performed is set as dm1, and a virtual distance of an operation that should not be performed is set as dm2 such that d (operation) 1<d (operation) 2. In the case of FIG. 10, the operation that is unnecessary but may be performed is, for example, an operation that increases the brightness of a monitor, and the operation that should not be performed is an operation that increases the amount of fuel to be supplied to a furnace, for example.

Returning to FIG. 12, it is determined in Step S302 whether or not the difference calculated in Step S301 is equal to or smaller than a threshold Th0 that is sufficiently small. If the difference is equal to or smaller than Th0 as a result of the determination, it is determined that the relationship is sufficiently close to the relationship in the first state, and the flow is ended without doing anything. On the other hand, if the difference exceeds the threshold Th0 as a result of the determination, the processing proceeds to Step S303.

In Step S303, it is determined whether the difference calculated in Step S301 is equal to or smaller than a threshold Th1. If the difference is equal to or smaller than the threshold Th1 as a result of the determination, the degree of abnormality of the user (operator) is assumed to be low, and the processing proceeds to Step S401. In Step S401, for example, the user (operator) is urged to take a break, or attention is called for the user (operator) to reflect on his or her state through a screen of the user (operator). On the other hand, if the difference exceeds the threshold Th1, the processing proceeds to Step S304.

In Step S304, it is determined whether the difference is equal to or smaller than a threshold Th2 which is greater than the threshold Th1. If the difference is equal to or smaller than the threshold Th2 as a result of the determination, the degree of abnormality of the user (operator) is assumed to be medium, and the processing proceeds to Step S402. In Step S402, a sound is also used to warn the user (operator) of the user (operator)'s own abnormality. Here, the sound may be a buzzer sound or the like, and it may be configured such that a specific warning or a suggestion for avoidance is made with a voice such as “You are out of concentration. Please be careful” and “Impatience has been detected. Please consider user change”. . . . On the other hand, if the difference exceeds the threshold Th2, the abnormality of the user (operator) is assumed to be high, and the processing proceeds to Step S403. In Step S403, a warning is issued on the screen with the sound not only to the user (operator) but also to a higher-level administrator.

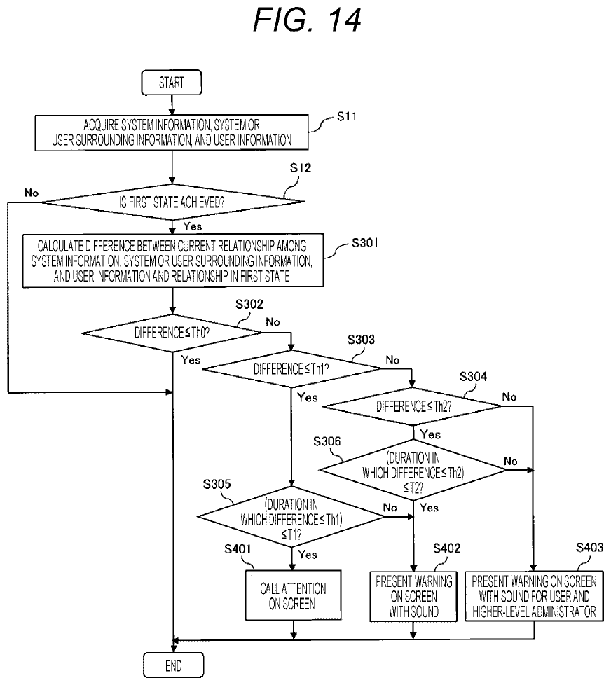

Note that the control mode may be changed to a stricter mode if a slight or moderate abnormality in the user (operator) state continues. FIG. 14 is a flowchart illustrating a control mode change flow when the abnormality in the user (operator) state continues. Step S11, Step S12, Step S301, Step S302, and Step S303 are the same as those in FIG. 12 described above, and thus, the description thereof will be omitted. If it is determined in Step S303 that the difference is equal to or smaller than the threshold Th1, the processing proceeds to Step S305. In Step S305, it is determined whether the duration of a state where there is a difference and the difference is equal to or smaller than the threshold Th1 is equal to or less than a predetermined time T1. If the duration is equal to or smaller than the threshold T1, it is determined that the abnormal state has not continued for a long time, the processing proceeds to Step S401, and the processing described with reference to FIG. 12 is executed. On the other hand, if the duration of the state where there is the difference and the difference is equal to or smaller than the threshold Th1 exceeds the predetermined time T1, the processing proceeds to Step S402.

If the difference exceeds the threshold Th1 in Step S303, the processing proceeds to Step S304. In Step S304, it is determined whether the difference is equal to or smaller than a threshold Th2 which is greater than the threshold Th1. If the difference is equal to or smaller than the threshold Th2 as a result of the determination, the processing proceeds to Step S306. In Step S306, it is determined whether the duration of a state where the difference is equal to or smaller than the threshold Th2 is equal to or less than a predetermined time T2. Note that it is desirable that T2 T1. This is because it may be necessary to take a measure early as the abnormality is stronger. If the duration is equal to or less than T2, the processing proceeds to Step S402. On the other hand, if the difference exceeds the threshold T2 in Step S304, it is determined that a stronger warning is required, and the processing proceeds to Step S403.

With the above configuration, it is possible to detect the abnormality of the user (operator), change the control mode, and guide the state of the user (operator) so as to make the operation normal. Further, a control mode that does not cause any shortage or trouble can be selected according to the degree of abnormality of the user (operator).

Note that if the difference in the relationship between the system information and the user information and the difference between the system or user surrounding information and the user information are different in magnitude, the above-described determination flow is performed using one with the larger difference. As a result, the determination can be made on the safe side.

When it is detected by user information acquisition that a user (operator) for which the acquisition of the relationship in the first state has not been completed is operating, an average relationship may be obtained from data of past users (operators) and applied. Alternatively, if a gender or an age of the user (operator) is known, an average relationship may be calculated and applied using data of users (operators) of the same gender, age, or generation.

As described above, according to the present embodiment, it is possible to provide the device control apparatus and the device control system capable of learning the range or area (hereinafter, may be simply referred to as the relationship) that needs to be acquired as the relationship between the state of the control object and the state of the user, and suitably changing the control mode when the relationship is different from the normal one. For example, when the user is tense in a case where the control object is normal, or when the user is relaxed in a case where the control object is abnormal, it can be determined that the state of the user is abnormal.

### Second Embodiment

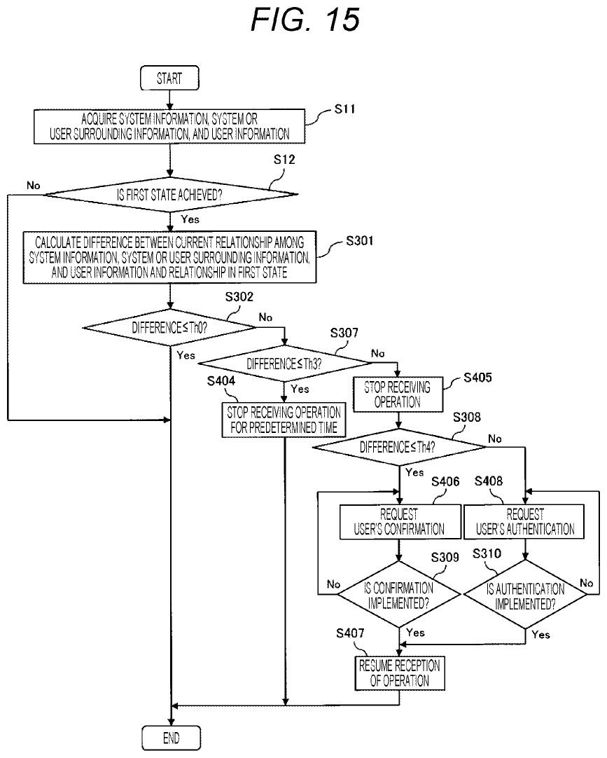

FIG. 15 is a flowchart when a device control apparatus of a second embodiment according to another embodiment of the present invention changes to a control mode in which an operation of a user is invalidated for a certain period of time. The present embodiment is different from the first embodiment in that the changed operation mode in a case where a difference from a relationship in the first state is found from a user invalidates an operation of the user for a certain period of time. The device control system 1 and the device control apparatus 10 have the same configuration as those of the first embodiment described above. Details of a difference from the first embodiment will be described hereinafter.

As illustrated in FIG. 15, in Step S301, a difference between a current relationship among system information, system or user surrounding information, and user information and the relationship in the first state is calculated in the same manner as in the first embodiment. In Step S302, it is determined whether the difference is equal to or smaller than a predetermined value Th0 that is sufficiently small. If the difference is equal to or smaller than the threshold Th0 as a result of the determination, it is determined that the relationship is sufficiently close to the relationship in the first state, and the flow is ended without doing anything. On the other hand, if the difference exceeds the threshold Th0, the processing proceeds to Step S307.

In Step S307, it is determined whether the difference is equal to or smaller than a threshold Th3. If the difference is equal to or smaller than the threshold Th3 as a result of the determination, the degree of abnormality of the user (operator) is assumed to be low, the processing proceeds to Step S404, and the reception of the operation of the user (operator) is stopped for a predetermined time. Note that the state of the user (operator) is likely to differ from a desired state at this time, and thus, it is preferable to notify the user (operator) of that the reception of the operation is stopped for the predetermined time through a human-machine interface such as a screen and a voice. On the other hand, if the difference exceeds the threshold Th3, the processing proceeds to Step S405, and the reception of the user (operator) operation is stopped first. Then, the processing proceeds to Step S308.

In Step S308, it is determined whether the difference is equal to or smaller than a threshold Th4 that is greater than the threshold Th3. If the difference is equal to or smaller than the threshold Th4 as a result of the determination, it is determined that the degree of abnormality of the user (operator) is medium, and the processing proceeds to Step S406 to urge the user to operate a switch for confirmation. Thereafter, when the operation of confirming the user is detected in Step S309, the processing proceeds to Step S407 to resume the reception of the user's operation. On the other hand, if the difference exceeds the threshold Th4 in Step S308, the processing proceeds to Step S408 to request an operation for authentication of the user, such as presenting an authentication card and entering a password. Thereafter, if the authentication operation of the user is confirmed in Step S310, the processing proceeds to Step S407 to resume the reception of the user's operation.

With this configuration, when the abnormality of the user is low, it is possible to stop receiving the user's operation for a short time and to provide the user with time to reflect his/her own operation. If the degree of abnormality of the user is medium, the user can be provided with a longer time for the reflection by interposing another simple operation of the user. When the abnormality of the user becomes high, the user is made to perform a more complicated operation and provided with a longer time for the reflection while confirming that the complicated operation can be performed correctly.

Note that another operation may be performed in Step S406 without being limited to the above-described operation as long as the operation is based on the idea that the user is made to perform a simple operation. Further, Step S408 is not limited to the above-described operation, and may be another operation as long as the operation is based on the idea that the user is made to perform a more complicated operation than Step S406. Alternatively, the reception of the user's operation may be stopped for a predetermined time longer than that in Step S404.

Further, the threshold Th3 and the threshold Th4 may be defined regardless of the threshold Th1 and the threshold Th2, but may be defined as Th1<Th2<Th3<Th4.

According to the present embodiment, when the abnormality of the user is low, it is possible to stop receiving the user's operation for a short time and to provide the user with time to reflect his/her own operation as described above, in addition to the effect of the first embodiment. If the degree of abnormality of the user is medium, the user can be provided with a longer time for the reflection by interposing another simple operation of the user. Then, when the abnormality of the user becomes high, the user can be made to perform a more complicated operation and provided with a longer time for the reflection while confirming that the complicated operation can be performed correctly.

### Third Embodiment

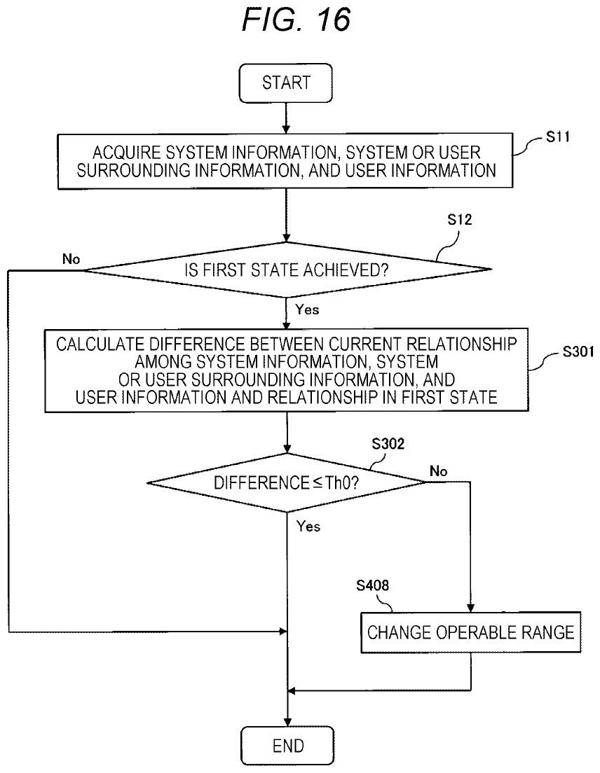

FIG. 16 is a flowchart when a device control apparatus of a third embodiment according to still another embodiment of the present invention changes an operable range of a user. The present embodiment is different from the above-described first embodiment in that a changed control mode changes the user's operable range, in other words, changes the user's operation authority. The device control system 1 and the device control apparatus 10 have the same configuration as those of the first embodiment described above. Details of a difference from the first embodiment will be described hereinafter.

A content different from the first and second embodiments due to the above difference is described below.

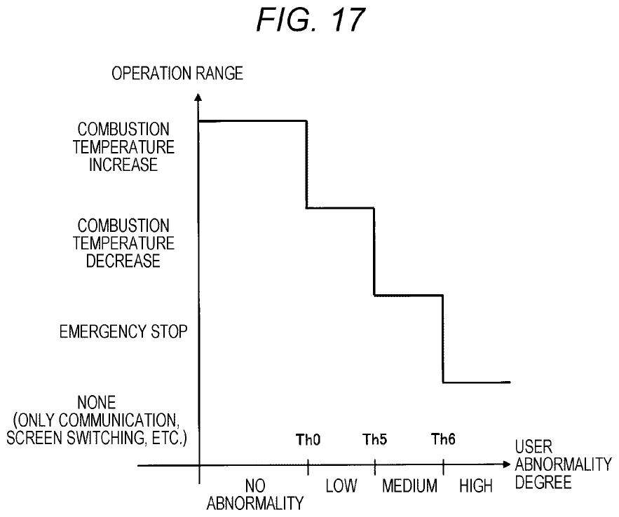

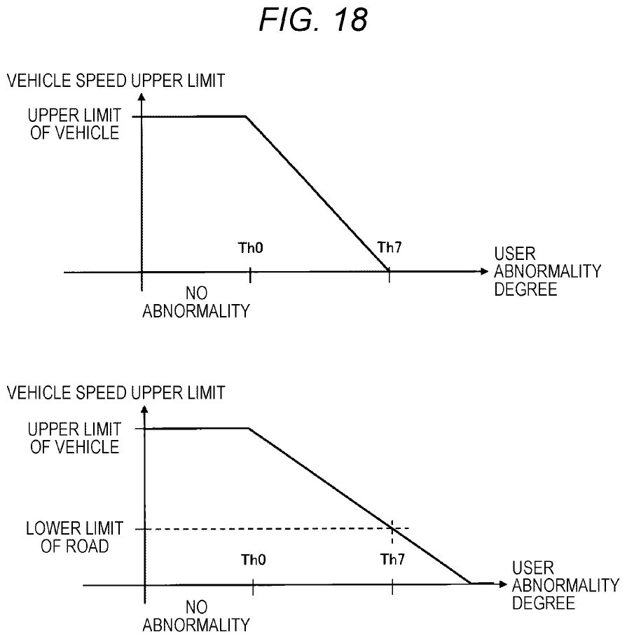

As illustrated in FIG. 16, if it is determined in Step S302 that a difference is larger than a threshold Th0 that is sufficiently small, the processing proceeds to Step S408. In Step S408, the operable range of the user (operator) is changed. On the other hand, if it is determined in Step S302 that the difference is equal to or smaller than the threshold Th0 that is sufficiently small, the processing ends without changing the operable range. Here, a method for changing the operable range of the user (operator) may be a stepwise change or a continuous change depending on the magnitude of the difference. FIG. 17 is a graph illustrating an example of the stepwise change of the operable range, and FIG. 18 is a graph illustrating an example of the continuous change of the operable range.

In the case of the stepwise change, the user's operable range (operation authority level) with a preset authority range is defined in advance, and the authority is lowered by one step when the degree of abnormality of the user (operator) becomes higher than a threshold. As an example, FIG. 17 illustrates an example of how to lower the operation authority in a thermal power plant as the control object 106. While the difference is equal to or smaller than the threshold Th0, the user (operator) is allowed to perform the entire operation. If the difference exceeds the threshold Th0, and is equal to or smaller than a threshold Th5 that is greater than the threshold Th0, the operable range is changed such that an operation that is likely to lead to dangerous events is particularly impossible. If the difference further exceeds the threshold Th5 and is equal to or smaller than a threshold Th6 that is greater than the threshold Th5, the operable range is changed such that not only the operation that is likely to lead to dangerous events but also an operation that leads to loss of profit (in the example of FIG. 17, an operation of lowering a combustion temperature which causes reduction in the amount of power generation) is impossible, either. If the difference further exceeds the threshold Th6, the operable range is changed such that only the operation that does not directly affect the operation of the control system is possible.

With this configuration, when the user's state is abnormal, that is, there is a possibility that it is difficult to make a normal determination, it is possible to prevent more dangerous control or to prevent an unnecessary operation from being received in the event of a panic or poor physical condition according to the user's operation.

An example of the case of the continuous change will be described by taking an automobile equipped with a driver assist system capable of driving at “level 1” and “level 2” of automatic driving as an example. As the degree of abnormality of a user (driver) becomes higher, for example, a vehicle speed and an acceleration in a traveling direction that the driver can output are limited. FIG. 18 illustrates an example of a method for changing an upper limit value of the vehicle speed as the operable range. In the upper graph of FIG. 18, only an upper limit value of a vehicle body itself limits the vehicle speed that the user (driver) can output while the difference is equal to or smaller than the threshold Th0. When the difference exceeds the threshold Th0, the vehicle speed that the user (driver) can output is lowered according to the degree of abnormality of the user (driver). If the user (driver) is so impatient as to panic or exceeds a threshold Th7, which is determined as a significantly poor physical condition, the limit is applied so as not to output the speed, that is, so as to prevent traveling. Note that it may be configured such that only a vehicle speed below the limit vehicle speed is output when exceeding the threshold Th7, on a road with a lower limit value of the vehicle speed limit, such as highways as illustrated in the lower graph of FIG. 18.

According to the present embodiment, when the user's state is abnormal, that is, when there is a possibility that it is difficult to make a normal determination, it is possible to prevent more dangerous control according to the user's operation as described above, in addition to the effect of the first embodiment. Further, it is possible to prevent the unnecessary operation performed by the user from being received in the event of the panic or poor physical condition.

### Fourth Embodiment

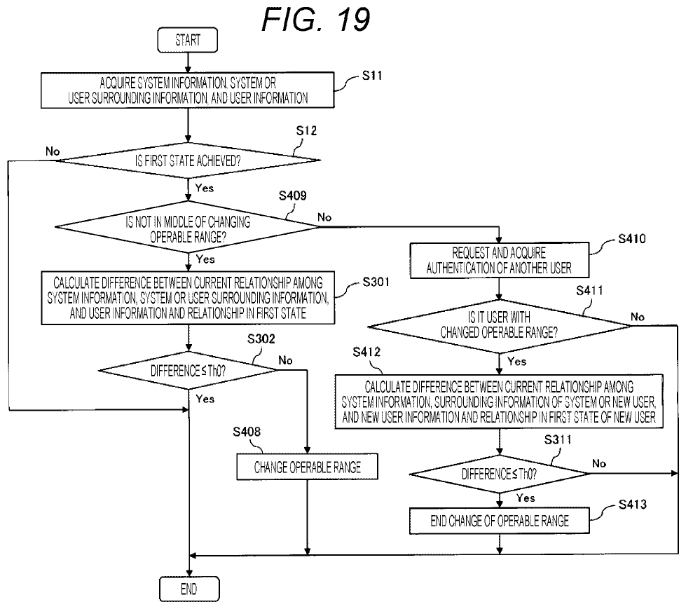

FIG. 19 is a flowchart when a device control apparatus of a fourth embodiment according to still another embodiment of the present invention returns from a mode of changing an operable range of a user. The present embodiment is different from the first embodiment in terms of including a function of authenticating a user, a function of authenticating a new user different from the user, and a function detecting that the new user different from the user is in the same relationships between the user and a system and between the user and a surrounding environment in the first state of the user in order to return from the mode of changing the operable range of the user. The device control system 1 and the device control apparatus 10 have the same configuration as those of the first embodiment described above. Details of a difference from the first embodiment will be described hereinafter.

As illustrated in FIG. 19, after determining that the first state is not achieved in Step S12, the processing proceeds to Step S409, and it is confirmed whether an operable range has already been changed. If the operable range has not been changed, the processing proceeds to Step S301, and the processing proceeds in the same manner as in the flow of FIG. 18. On the other hand, if the operable range has already been changed, the processing proceeds to Step S410.

In Step S410, the authentication of another user different from a current user is requested and acquired. Thereafter, in Step S411, it is confirmed whether the acquired user information is not a user whose operable range is being currently changed. If there is no change for a user, in Step S412, a difference between a relationship in the first state and a current relationship of a new user is calculated from information on the new authenticated user, surrounding information, and system information. Thereafter, if it is determined in Step S311 that the calculated difference is equal to or smaller than a threshold Th0 that is sufficiently small, the operable range is restored to a normal one. On the other hand, if it is determined in Step S411 as the user with the changed operable range or the difference in the new user exceeds the threshold Th0 in Step S311, the processing ends without restoring the operable range. At this time, it is advantageous to notify no restoration of the operable range and a reason therefor.

Note that only the function of authenticating another user different from the user may be used without using all the above-described functions. That is, the processing may jump to Step S413 in the case of the user for which the determination in Step S411 has not changed.

According to the present embodiment, it is possible to ask the determination on another user, and to further improve the safety as described above, in addition to the effect of the first embodiment.

The above-described first to fourth embodiments can be similarly used for a plant control system as the control object 106, an automobile control system including a driver assist system, a construction machine similarly including an operator assist system, and the like.

Note that the present invention is not limited to the above-described embodiments, but includes various modifications. For example, the above-described embodiments have been described in detail in order to describe the present invention in an easily understandable manner, and are not necessarily limited to one including the entire configuration that has been described above. Further, a part of the configuration of a certain embodiment can be replaced with the configuration of another embodiment, and the configuration of another embodiment can be added to the configuration of a certain embodiment.

### REFERENCE SIGNS LIST

1 device control system
10 device control apparatus
101 user information acquisition unit
102 system information acquisition unit
103 surrounding environment information acquisition unit
104 relationship determination unit
105 control mode change unit
106 control object
201 area acquired as first state
202 relationship between state of thermal power plant and state of user (operator) obtained during acquisition of data of first state
203 combination of thermal power plant and internal state of user (operator) that is not within related range
204 combination of thermal power plant and internal state of user (operator) that is within related range
206 combination of thermal power plant and internal state of user (operator) in another user
207 median of user information in area where there is a strong relationship between state of thermal power plant and state of user (operator) obtained during acquisition of data of first state in current plant state
301 control panel of thermal power plant
302 area of operation that needs to be taken by user (operator)
303 monitor
304 area that should not be operated because the situation becomes worse

1. A device control apparatus comprising:
an information acquisition unit that acquires first information on a user, second information on a control object, and third information on a surrounding environment of the user or the control object;
a relationship determination unit that acquires a range or area that needs to be acquired as a relationship between the first information and the second information and a range or area that needs to be acquired as a relationship between the first information and the third information in a first state defined from states of the user and the control object; and
a control mode change unit that changes a control mode of the control object when at least one of the range or area that needs to be acquired as the relationship between the first information and the second information and the range or area that needs to be acquired as the relationship between the first information and the third information is different from the first state.

2. The device control apparatus according to claim 1, wherein
the relationship determination unit acquires the range or area that needs to be acquired as the relationship between the first information and the second information and the range or area that needs to be acquired as the relationship between the first information and the third information in the first state for each user.

3. The device control apparatus according to claim 2, wherein
the first information on the user includes at least any one of information for authenticating the user, a motion of the user, and biometric information of the user.

4. The device control apparatus according to claim 3, wherein
the second information on the control object includes at least any one of a state that is controllable by the user, a phenomenon or state that occurs in association with a state controlled by the user, and a phenomenon or state that occurs regardless of an intention of the user.

5. The device control apparatus according to claim 4, wherein
the first state is a mode for learning the relationship between the first information on the user and the second information on the control object, and the relationship between the first information on the user and the third information on the surrounding environment of the user or the control object.

6. A device control system comprising:
a control object; and
a device control apparatus that controls the control object,
wherein the device control apparatus includes:
an information acquisition unit that acquires first information on a user, second information on a control object, and third information on a surrounding environment of the user or the control object;
a relationship determination unit that acquires a range or area that needs to be acquired as a relationship between the first information and the second information and a range or area that needs to be acquired as a relationship between the first information and the third information in a first state defined from states of the user and the control object; and
a control mode change unit that changes a control mode of the control object when at least one of the range or area that needs to be acquired as the relationship between the first information and the second information and the range or area that needs to be acquired as the relationship between the first information and the third information is different from the first state.

7. The device control system according to claim 6, wherein
the relationship determination unit acquires the range or area that needs to be acquired as the relationship between the first information and the second information and the range or area that needs to be acquired as the relationship between the first information and the third information in the first state for each user.

8. The device control system according to claim 7, wherein
the first information on the user includes at least any one of information for authenticating the user, a motion of the user, and biometric information of the user.

9. The device control system according to claim 8, wherein
the second information on the control object includes at least any one of a state that is controllable by the user, a phenomenon or state that occurs in association with a state controlled by the user, and a phenomenon or state that occurs regardless of an intention of the user.

10. The device control system according to claim 9, wherein
the first state is a mode for learning the relationship between the first information on the user and the second information on the control object, and the relationship between the first information on the user and the third information on the surrounding environment of the user or the control object.
